(19) United States
(12) Patent Application Publication
(10) Pub. No.: US 2009/0237487 A1
(43) Pub. Date: Sep. 24, 2009

(54) Video Intercom Station With Multimedia Functions

(76) Inventor: Ernesto Santini, Sozzago-Novara (IT)

Correspondence Address: HEDMAN & COSTIGAN P.C., 1185 AVENUE OF THE AMERICAS, NEW YORK, NY, 10036, US

(21) Appl. No.: 12/085,153

(22) PCT Filed: Nov. 27, 2006
(86) PCT No.: PCT/EP2006/011389

§ 371 Date: May 15, 2008

(30) Foreign Application Priority Data
Nov. 28, 2005 (IT) MI2005A002267

(51) Int. Cl. H04N 7/14

(52) U.S. Cl. 348/14.01; 348/E07.001

(57) ABSTRACT

A video intercom station (20) with multimedia functions, usable as inside video intercom position, which foresees the function of terminal for the use of remote multimedia sources (21), utilising the connection of the terminal and the remote multimedia source (21) to a multimedia non-polarised two-wire bus (23); the inside position permits displaying video signals and reproducing audio signals, also stereo, emitted by a remote multimedia source (21) which is commonly available commercially, such as a DVD reader, a satellite decoder, a radio, a TV, a Hi-Fi stereo system, etc., and also permits interacting with the remote source (21), sending it turning on, turning off, navigation commands in the source function menu, etc.

The present invention refers in general to a video intercom station with multimedia functions.

More in particular, the invention regards a signal transmission system in a circuit with two non-polarised multimedia wires, for video systems and stereophonic sound diffusion systems, adapted for transferring audio signals, of alarm or related to other accessory automatisms.

The continuous needs of domotic functions and applications, from antitheft to video-control, from comfort to energy management, from communications to lighting, forces the installer to foresee the placement of a considerable number of electrical cables, which exponentially increase with respect to the number of functions required inside a building, along with the consequent production and running costs and the need to employ specialised personnel for carrying out the foreseen connections.

The domotic systems of the new generation must moreover be capable of communicating with the outside world, so to be able to interact with the building from the fixed line and mobile telephones and/or from any Personal Computer, via local network or the Internet, in order to prearrange the house for the desired reception, for example, activating the heating or turning on the washing machine, restoring the electrical energy, turning on several light points, opening a specific number of motorised rolling shutters, adjusting the temperature in the rooms, displaying video and/or audio signals from one or more remote multimedia sources which are commonly available commercially, interacting with the remote sources so to send commands.

All of the above overly increases the cabling in the building, which must furthermore be able to prearrange all normal telephone functions in addition to that of communication between telephone and outside intercom or video intercom position, activation of an electrical lock, the stairway lights or any other device.

The object of the present invention is therefore that of making a video intercom station with multimedia functions which overcomes the abovementioned drawbacks of the prior art and in particular that of making a video intercom system with multimedia functions which has all of the video intercom functions which has the priority of functioning and which foresees at the same time the terminal function for the use of remote multimedia sources, utilising the terminal and source connection to a non-polarised two-wire multimedia bus.

Another object of the present invention is that of making a video intercom station with multimedia functions which is highly reliable and at relatively limited costs with respect to the prior art, practicable functions being equal.

Further object of the present invention is that of making a video intercom station with multimedia functions whose cabling is relatively simplified with respect to traditional connection systems, practicable functions being equal.

These and other objects, according to the present invention, will be achieved by making a video intercom station with multimedia functions according to the enclosed claim 1.

The further dependent claims contain technical characteristics of detail of the invention.

Advantageously, the video intercom position according to the invention is totally integrated in the home automation systems and permits using the devices present in the dwelling in an advanced and integrated manner.

It is therefore possible, by means of this system, to display video and reproduce and/or record audio signals, also stereo, as well as control all remote sound source functions and/or visually and acoustically survey the settings by remote control.

The inside position therefore consists of a terminal for the use of remote multimedia sources, utilising a multimedia non-polarised two-wire bus.

The system can therefore be configured to permit the user interaction and listening, also stereo, of an outside sound source, such as recorders, video recorders, DVD readers, radios, TVs, satellite decoders or Hi-Fi systems.

Finally, by integrating a series of modules equipped with telecameras and microphones into the sound diffusion components, it is possible to implement the function of acoustic and environmental surveillance into the system.

Further characteristic of the invention is the modularity of the system, which permits choosing one or more functionalities and amplifying them as desired over time, audio accessory functions, those of alarm or those related to particular automatisms of the system.

The display and interaction system of the video intercom station according to the invention therefore permits transmitting images and audio signals, as well as the power supply and other control signals on only two wires of a multimedia bus.

Moreover, the video intercom station offers, in addition to the normal video intercom and video-control functions, which are priorities, also the possibility to interact with the domotic systems, integrating with the home system management; in fact, in addition to achieving all of the two-wire digital video intercom functions, the system permits managing the home, from safety to comfort, even entertainment (it is possible, as a matter of fact, to activate the light or rolling shutter automations, turn on or listen to a musical source of the sound diffusion system and adjust its volume, display the status of the alarms and/or adjust the temperature in the various dwelling environments, in the presence of the thermoregulation system).

Further characteristics and advantages of a video intercom station with multimedia functions, according to the present invention, will be more evident from the following description, related to an exemplifying and non-limiting embodiment, referred to the enclosed drawings wherein:

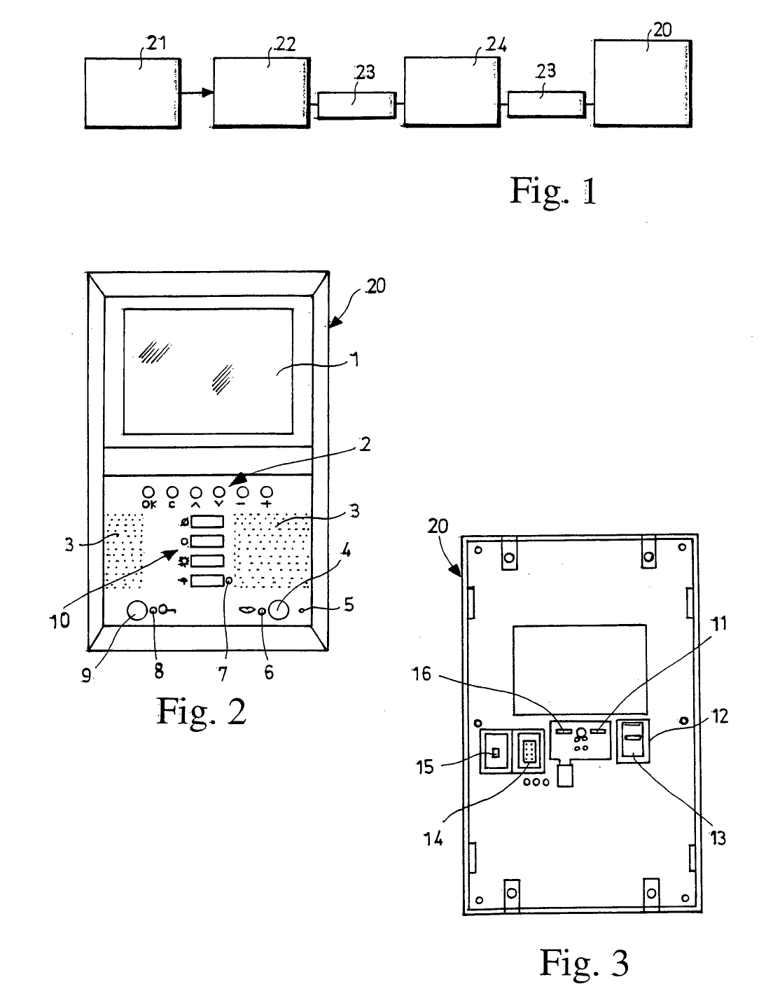

FIG. 1 is a block diagram of the functioning of the video intercom station with multimedia functions, according to the present invention;

FIG. 2 is a front view of the video intercom station with multimedia functions, according to the present invention;

FIG. 3 is a rear view of the video intercom station with multimedia functions, according to the present invention.

With reference to the abovementioned FIGS. 1-3, the video intercom station with multimedia functions, according to the invention, generically indicated with 20, comprises on the front panel (FIG. 2) a colour display screen 1 which displays the menus which guide the use and programming operations and shows the images taken by the outside position or by other telecameras or the images generated by multimedia video sources (for example, a DVD reader), a navigation keyboard 2, which permits navigating inside the menus, the confirmation or cancellation of the programming operations, a pair of loudspeakers 3, which permit the diffusion of voice and stereo sound, a connection key 4, which activates or deactivates the connection, a microphone 5, an LED diode 6 of connection, an LED diode 7 of call exclusion, an LED diode 8 of lock activation, a key 9 which permits the activation of the electrical lock of the associated or connected outside position and a series of keys 10 usable for the management of the video intercom functions such as enabling or disabling the microphone during a sound connection, activating the associated outside position and other possible outside positions and/or telecameras in cyclic succession, activating the stairway lights, enabling or disabling of the call bell.

On the back panel (FIG. 3) of the video intercom station with multimedia functions, according to the invention, the following are identified: a connection seat 11 for the connection to the bus of the multimedia two-wire digital system, a seat 12 of the configurators, an ON/OFF microswitch 13 of segment termination, a connector 14 for the connection, by means of an interface-cable, to a configuration Personal Computer, a connector 15 of “Mini-USB”, type for the connection to the Personal Computer, a connector 16 for a supplementary power supply.

The video intercom station 20 consists of an inside terminal for the use of remote multimedia sources 21, commonly available commercially, whose video and/or audio (also stereo) signals are sent, by means of the input 22, on the two-wire multimedia bus 23 and distributed by means of various system accessories 24, reaching the multimedia terminal, by means of the connection 11, by utilising the connection of terminal and multimedia source to the multimedia bus 23 (FIG. 1).

The system accessories in particular permit the multimedia terminal to display images and reproduce stereo audio signals, reproduced by the multimedia source 21 which can consist of, for example, DVD readers and/or cassettes, video recorders, satellite decoders which decode TV channels, radios, TVs, Hi-Fi stereos, etc.

Moreover, the station 20 permits interacting with the remote source 21, being able to send it commands such as turning on the source 21, turning off of the source 21, changing the track reproduced by the source 21, etc.

During the functioning, in case of a call from the outside position, the image taken by the outside telecamera is displayed on the screen 1.

Moreover, pressing one of the navigation keys 2, the set functions menu appears; such menu comprises (priority) video intercom functions, such as opening the lock of the outside position, enabling the response to a call, enabling or disabling the microphone 5, turning on the outside position, turning on the stairway lights, enabling or disabling the call bell.

Further communication functions include the activation of an actuator or outside position (for example, the opening of a secondary gate), the intercommunicating function (which permits the conversation with other video intercoms or intercoms installed in the home or in other apartments), the enabling of a selected telecamera and/or the cyclic scanning of the images taken by various surveillance telecameras, while other domotic functions foresee the setting of scenarios, the enabling or disabling of antitheft alarms, the signalling of the latest occurring alarm events (indicating the date, time and type of alarm), the partialisation of the system, the stereo sound diffusion, by means of an integrated amplifier and the loudspeakers 3, the control, display and adjustment of the temperature in the various zones of a dwelling and of the status of the main control unit, by means of interaction with a thermoregulation system, and possible other accessory or personalised functions.

The domotic functions are permitted by means of the integration, direct or by means of a configuration interface, with the domotic systems of the home; such integration is made possible due to the use of the two-wire multimedia bus 23, which permits the exchange of information between the systems.

From the above description, the characteristics are clear of the video intercom station with multimedia functions, object of the present invention, as its advantages are clear.

In particular, these regard the following aspects:
reduced installation times of the entire cabling, with respect to the prior art;
reduction of the overall cost of the installed cables, with respect to the prior art;
use of personnel which is relatively unspecialised, due to the fact that the installation operations are substantially facilitated with respect to the prior art;
possibility of displaying video and reproducing or recording audio signals, also stereo, and at the same time controlling the functions of remote sound sources and/or audio/video surveillance;
use of remote multimedia sources for the display of images and for the contemporaneous stereo listening of an outside audio/video source, such as recorders, video recorders, DVD readers, radios, TVs, satellite decoders or Hi-Fi systems;
possibility of transmitting images and audio signals, power supply and other control signals on only two wires of a multimedia bus;
possibility of using the functions of the two-wire digital video intercom which are considered priority, and at the same time interacting with the domotic systems of a home, integrating with the management of the home system, activating the automation of lights or rolling shutters, listening and adjusting a musical source of the sound diffusion system, displaying the status of the alarms and/or the adjustment of the temperature in the various home environments.

Finally, it is clear that numerous variants can be made to the video intercom station with multimedia functions in question, without departing from the novelty principles inherent to the inventive idea, as it is clear that, in the practical actuation of the invention, the materials, shapes and dimensions of the illustrated details can be of any type and the same can be substituted with other technically equivalent elements.

1. Video intercom station (20) with multimedia functions, usable as inside video intercom position or terminal and employing the functions of a two-wire video intercom system, characterised in that said terminal is connected to at least one remote multimedia source (21), by means of at least one multimedia non-polarised two-wire bus (23), so to be able to display video signals and to reproduce stereo audio signals emitted from said remote multimedia source (21), said video intercom station (20) being adapted to interact with said remote multimedia source (21) by means of turning on, turning off and/or navigation commands in the functions menu.

2. Video intercom station (20) as in claim 1, characterised in that said remote multimedia source (21) is of the type of common commercial availability, such as a DVD reader, a satellite decoder, a radio, a TV, a Hi-Fi stereo system, etc.

3. Video intercom station (20) as in claim 1, characterised in that said station (20) comprises, on a front panel, a display screen (1) of the menus which guide the use and programming operations and of the images taken by the outside position or by other telecameras, a keyboard (2) of navigation inside the functioning menus, a pair of loudspeakers (3), which permit the diffusion of voice and stereo sound, a first activation or deactivation key (4) of the connection, at least one microphone (5), a series of LED signalling diodes (6, 7, 8), a second activation key (9) of at least one lock and a plurality of keys (10) usable for the management of the video intercom functions.

4. Video intercom station (20) as in claim 1, characterised in that said station (20) foresees, on a back panel, a first connection seat (11) for the connection to said multimedia bus (23), a second seat (12) for the connection of the configurators, a first connector (14) for the connection to a configuration Personal Computer, a second connector (15) for the connection to the Personal Computer and a third connector (16) for a supplementary power supply.

5. Video intercom station (20) as in claim 3, characterised in that said functioning menu comprises priority video intercom functions, such as opening the lock of the outside position, enabling the response to a call, enabling or disabling, said microphone (5), turning on the outside position, turning on the stairway lights, enabling or disabling the call bell.

6. Video intercom station (20) as in claim 3, characterised in that said functioning menu includes further communication functions, such as the activation of an actuator or an outside position, intercommunicating functions, functions of enabling at least one prearranged telecamera and/or cyclic scanning of the images taken by various surveillance telecameras.

7. Video intercom station (20) as in claim 3, characterised in that said functioning menu includes further domotic functions, such as the setting of scenarios, enabling or disabling antitheft alarms, signalling the latest occurring alarm events, partialising the system, diffusing stereo sound by means of said pair of loudspeakers (3), controlling, displaying and adjusting the temperature in the various zones of a dwelling and the status of the main control unit.

8. Video intercom station (20) as in claim 7, characterised in that said domotic functions are permitted by means of the integration, direct or indirect, with the domotic systems of a dwelling, by means of said multimedia bus (23) which permits the exchange of the information between the systems.

9. Video intercom station (20) with multimedia functions substantially as described above, illustrated in the enclosed drawings and for the specified objects.
